(19) United States
(12) Patent Application Publication
(10) Pub. No.: US 2014/0160148 A1
(43) Pub. Date: Jun. 12, 2014

(54) Context-Based Image Customization

(71) Applicants: Andrew J. Barkett, Redwood City, CA (US); David Harry Garcia, Sunnyvale, CA (US)

(72) Inventors: Andrew J. Barkett, Redwood City, CA (US); David Harry Garcia, Sunnyvale, CA (US)

(21) Appl. No.: 13/709,741

(22) Filed: Dec. 10, 2012

(51) Int. Cl. G06T 11/60

(52) U.S. Cl. CPC G06T 11/60
USPC 345/619

(57) ABSTRACT

In one embodiment, a method includes receiving information associated with an image. Information regarding a viewing context for displaying the image may be received. The viewing context may comprise one or more factors, including, by way of example and not limitation: technical specifications for a display device, a physical environment of the display device, a state of the display device, and user preferences. Customization of the image may comprise modifying any aspect of the image, over the whole image, or just a portion of the image, such as, by way of example and not limitation: luminance, chrominance, resolution, etc. The image is customized with respect to the viewing context, and then the customized image is provided for display.

### TECHNICAL FIELD

This disclosure generally relates to customized image processing.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

### SUMMARY OF PARTICULAR EMBODIMENTS

Particular embodiments provide for customization of aspects of an image, including color saturation, hue, and brightness, amongst others. An image may be customized for display in accordance with a viewing context. The viewing context may comprise one or more factors, including, by way of example and not limitation: technical specifications for a display device, a physical environment of the display device, a state of the display device, and user preferences. Customization may occur manually or automatically. In particular embodiments, image customization may take place on a server, which may then send the customized image to a client device for display. In particular embodiments, image customization may also or alternatively take place on the client device, as a one-time operation or in real time, in accordance with a viewing context.

### BRIEF DESCRIPTION OF THE DRAWINGS

FIG. 1 illustrates an example method for providing customized image processing.

FIG. 2 illustrates an example interaction diagram for providing customized image processing.

FIG. 3 illustrates an example network environment associated with a social-networking system.

FIG. 4 illustrates an example social graph.

FIG. 5 illustrates an example computer system.

### DESCRIPTION OF EXAMPLE EMBODIMENTS

Particular embodiments provide for customization of aspects of an image, including color saturation, hue, contrast, and brightness, amongst others. An image may be customized for display in accordance with a viewing context. The viewing context may comprise one or more factors, including, by way of example and not limitation: technical specifications for a display device, a physical environment of the display device, a state of the display device, and user preferences. Customization of the image may comprise modifying any aspect of the image, over the whole image, or just a portion of the image, such as, by way of example and not limitation: luminance, chrominance, resolution, etc.

Technical specifications for the display device may include, by way of example and not limitation: maximum colors, screen resolution, screen dimensions, pixel density, pixels per degree, aspect ratio, maximum viewing angle, typical viewing distance, brightness, response time, photosensor capabilities, networking capabilities, GPS capabilities, battery life, processor specifications, memory usage, or storage capacity. Aspects of the physical environment may include, by way of example and not limitation: ambient light, location, time of day (e.g., mid-day, dusk/dawn, night-time), or time of year (e.g., season). Aspects of the state of the display device may include, by way of example and not limitation: power availability, user-configurable display settings, or network connectivity.

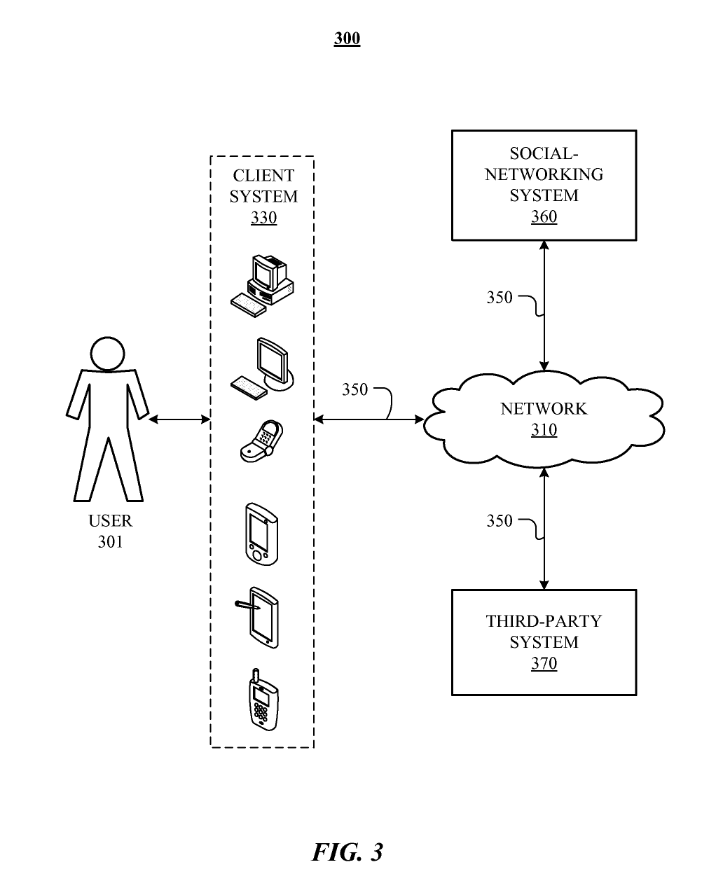

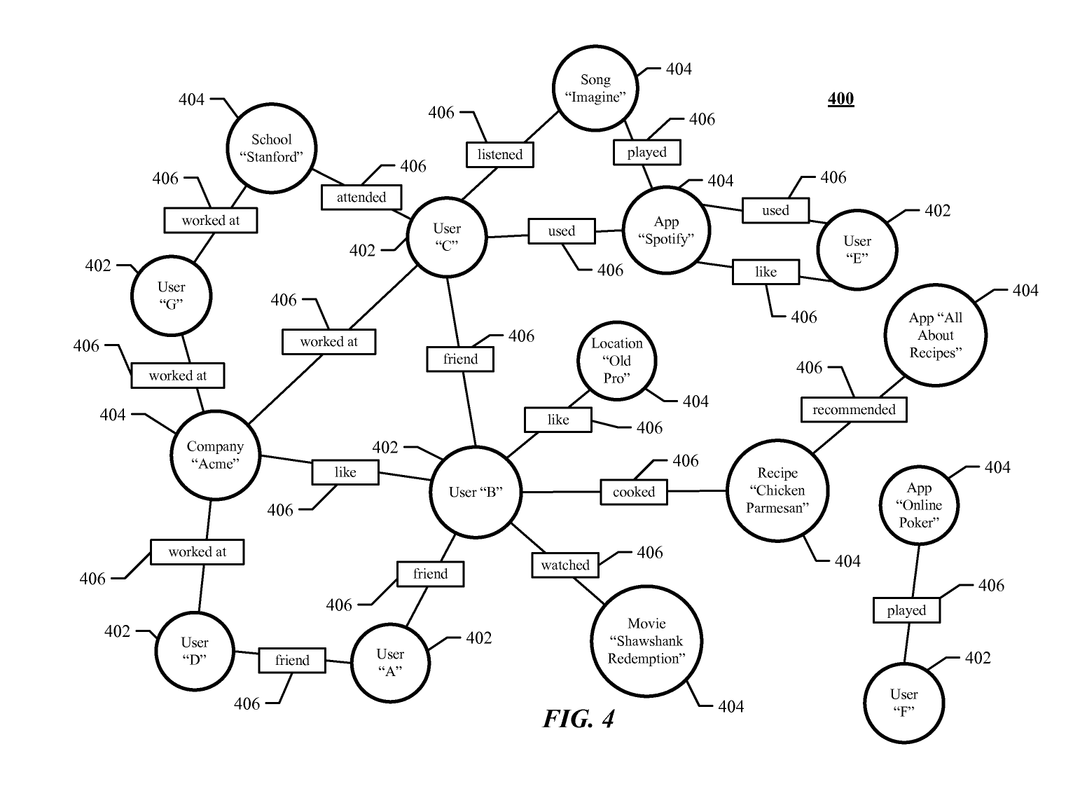

User preferences may comprise preferences of a user associated with the display device, preferences of an expert, or preferences of one or more social-networking connections of a user. In particular embodiments, the user preferences may be that of a user associated with the display device (e.g., the user may prefer high-dynamic range images) may be stored on a server in association with a profile of the user. In particular embodiments, the user preferences may be provided by an expert (e.g., a camera manufacturer or digital production company may provide configuration settings for different viewing contexts). In particular embodiments, the user preferences may comprise those of one or more social-networking connections of a user (e.g., if the user belongs to an interest group for gothic-style digital imagery, the preferences of one or more other users in the interest group may be considered). Example embodiments of social-networking systems are described in further detail with respect to FIG. 3. Example embodiments of social graphs, social-networking information, and content objects are described in further detail with respect to FIG. 4.

In particular embodiments, a high dynamic range (HDR) image may be uploaded (with any accompanying metadata) to a server. The HDR image may have been created based on a set of identical images of a subject, the only difference between each image in the set of images being that each image has a different exposure level. Techniques to adjust HDR images to modify luminance and chrominance are well-known by those of skill in the art. In particular embodiments, customizing the image may comprise customizing metadata associated with the image and providing the image with the customized metadata. In particular embodiments, customizing the image may comprise generating a new version of the image and providing the new version of the image.

Customization may occur manually (on a case-by-case basis) or automatically (according to one or more rules). For example, whenever a user requests an image, if customization occurs automatically as a client-side operation, the user's display device may assess the ambient light and the remaining available battery life prior to determining whether to modify the image. If the device does not have much battery life left, it may not perform the operations necessary to modify the image. In another example, if a user captures an image using their display device and then manually requests server-side customization, the user's display device may assess the availability of a network connection prior to uploading the image to a server to be customized. In this example, the image may be uploaded to a social-networking server, and then the user's preferences and preferences of any other designated users (e.g., those of a famous photographer or those of a friend) may be incorporated into the customization process. In another example, if the user always adjusts certain types of images to be darker/brighter/higher-or-lower contrast, similar images may be optimized in the same way.

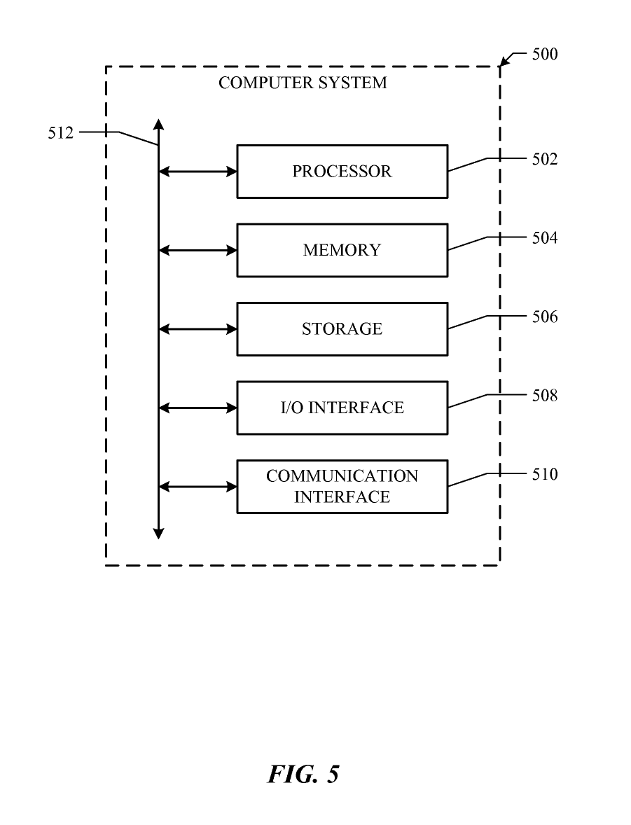

In particular embodiments, the server may immediately process the image upon receiving it, or the server may simply store the image and then process it on the fly as it is receives requests for the image. In particular embodiments, image customization may take place on the server, which may then send the customized image to a client device for display. In particular embodiments, image customization may also or alternatively take place on the client device, as a one-time operation or in real time, in accordance with the viewing context. Example embodiments of computing systems and computing devices are described in further detail with respect to FIG. 5.

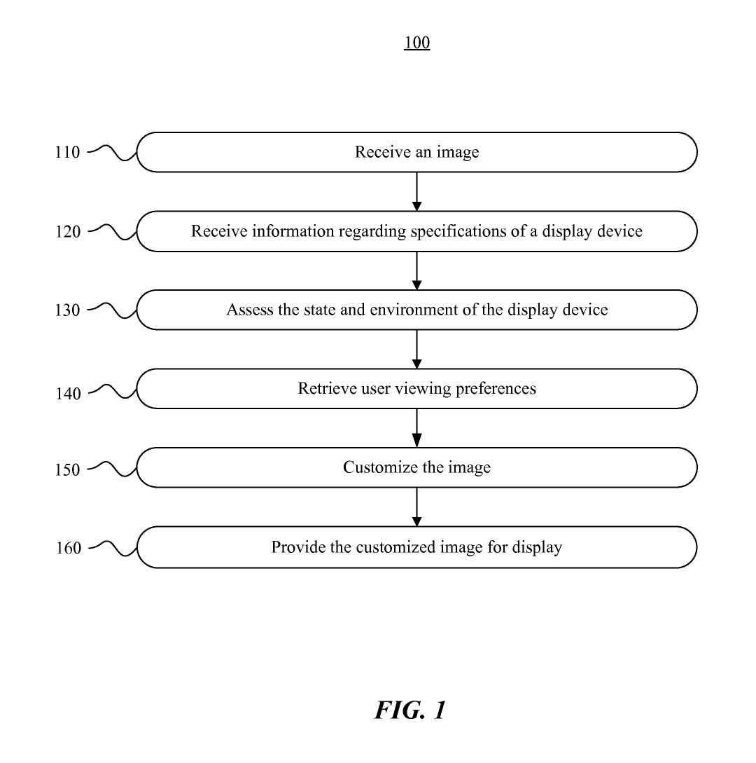

FIG. 1 illustrates an example method 100 for providing customized image processing. All of the steps of example method FIG. 1 may be performed as client-side operations, server-side operations, or as a combination of client- and server-side operations. The method may begin at step 110, where an image is received. The image may be received from any source, including, by way of example and not limitation, an image capture device, the user's computing device, upload by a user to a social-networking system or other server, or submission by or retrieval from a third-party system. In steps 120-140, viewing context information is gathered. As one of skill in the art would be aware, the viewing context may comprise any assortment of information that may be helpful or useful when determining how best to customize an image for display on a particular display device to a particular user.

At step 120, specifications of a display device are received. As discussed above, such specifications may be stored ahead of time, or they may be submitted and/or retrieved each time customization is performed for display on the display device. In particular embodiments, display devices may be classified into particular categories according to their technical specifications, and such information may be stored ahead of time, separately from any particular user's profile (aside from a possible indication of what category the user's display device falls into).

At step 130, an assessment of the state and physical environment of the display device is performed. Such an assessment may provide a basis for a determination of what type of customization may be desirable (e.g., to address issues with viewing the image in particular levels of ambient light), as well as whether or not any customization is desirable (e.g., may not be a good idea to attempt client-side customization if battery power is low or server-side customization if the available network bandwidth is insufficient to transmit the image).

At step 140, user viewing preferences may be retrieved. Such user preferences may be stored client-side, on the display device, or server-side. As discussed above, the user preferences may include any or all of the preferences of the user associated with the display device, expert users, or users of a social-networking system who are connected to the user associated with the display device. If multiple sources of user preferences are available, the various preferences may be ranked, weighted, or averaged, as appropriate. Alternatively, the user may choose to view various versions of the image modified in accordance with the differing preferences.

At step 150, once any viewing context information has been retrieved, received, analyzed, or otherwise accounted for, the image is customized. As described above, customization may comprise modifying metadata associated with the image, or it may involve directly modifying or creating a new version of the image. At step 160, the customized image is provided for display.

Particular embodiments may repeat one or more steps of the method of FIG. 1, where appropriate. Although this disclosure describes and illustrates particular steps of the method of FIG. 1 as occurring in a particular order, this disclosure contemplates any suitable steps of the method of FIG. 1 occurring in any suitable order. Moreover, although this disclosure describes and illustrates particular components, devices, or systems carrying out particular steps of the method of FIG. 1, this disclosure contemplates any suitable combination of any suitable components, devices, or systems carrying out any suitable steps of the method of FIG. 1.

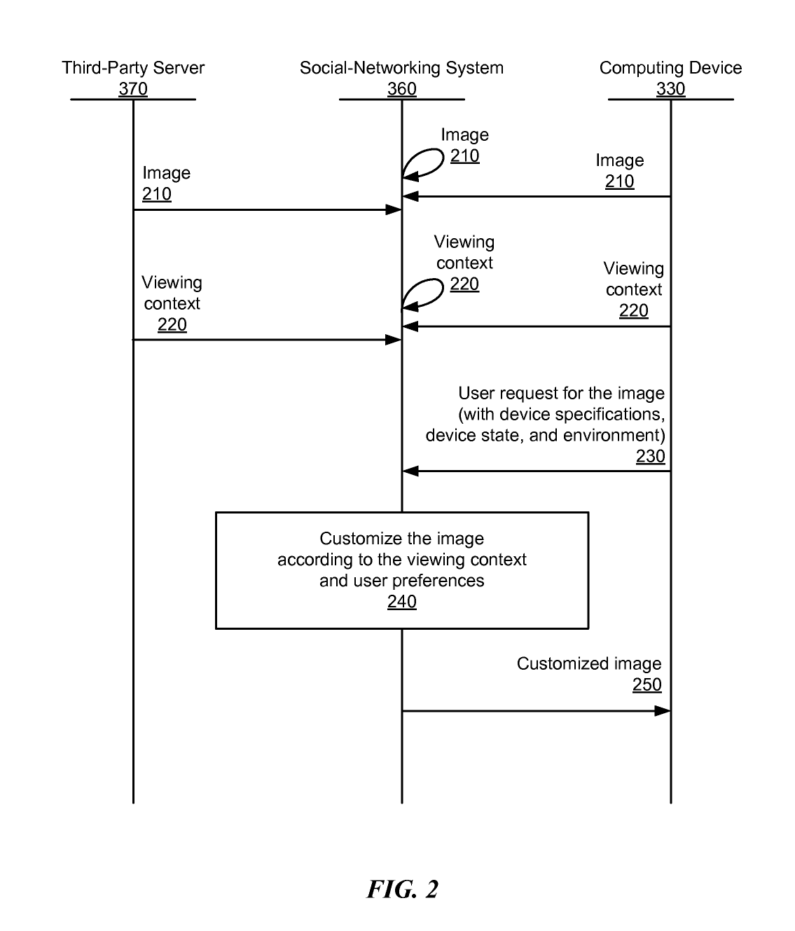

FIG. 2 illustrates an example interaction diagram for providing customized image processing. An image 210 may be received from computing device 330, social-networking system 360, or third-party server 370.

In particular embodiments, viewing context information 220 may be received from computing device 330, social-networking system 360, or third-party server 370. As described above, the viewing context may comprise one or more factors, including, by way of example and not limitation: technical specifications for a display device, a physical environment of the display device, a state of the display device, and user preferences.

In particular embodiments, a computing device 330 associated with a user of social-networking system 360 may send a user request 230 for the image 210 to social-networking system 360. The user request 230 may include viewing context information related to device specifications, device state, and the physical environment of the device. The user request 230 may also include information identifying the image 210 and/or information identifying the user, the device, or the combination of the user and the device. In particular embodiments, the device specifications may already be stored in association with a profile of the user.

In particular embodiments, social-networking system 360 may then customize 240 the image according to the viewing context and user preferences. Upon receiving the user request 230, social-networking system 360 may retrieve the user's viewing preferences from a profile associated with the user. In particular embodiments, social-networking system 360 may already have customized 240 the image prior to receiving the user's request for the image. For example, if a social-networking connection of the user tagged the user in the image, social-networking system 360 may anticipate that the user will submit a request to view the image and so customize the image as soon as the tag indication is received. In another example, if the image is posted by a user or entity in the social graph that the user is following (e.g., a celebrity or a news organization), social-networking system 360 may likewise anticipate that the user will submit a request to view the image and so customize the image for the user as soon as the image is uploaded.

In particular embodiments, social-networking system 360 may then provide 250 the customized image for display on computing device 330. In particular embodiments, the customized image may be cached or stored server-side and/or client-side, in accordance with different needs (e.g., if the same customized image will be used by default for all users having a particular display device, the image may be stored server-side, whereas a specific customization for a single user may simply be cached on their display device).

Particular embodiments may repeat one or more elements of the interaction diagram of FIG. 2, where appropriate. Although this disclosure describes and illustrates particular elements of FIG. 2 as occurring in a particular order, this disclosure contemplates various elements of the interaction diagram of FIG. 2 occurring in any suitable order. Moreover, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

FIG. 3 illustrates an example network environment 300 associated with a social-networking system. Network environment 300 includes a user 301, a client system 330, a social-networking system 360, and a third-party system 370 connected to each other by a network 310. Although FIG. 3 illustrates a particular arrangement of user 301, client system 330, social-networking system 360, third-party system 370, and network 310, this disclosure contemplates any suitable arrangement of user 301, client system 330, social-networking system 360, third-party system 370, and network 310. As an example and not by way of limitation, two or more of client system 330, social-networking system 360, and third-party system 370 may be connected to each other directly, bypassing network 310. As another example, two or more of client system 330, social-networking system 360, and third-party system 370 may be physically or logically co-located with each other in whole or in part. Moreover, although FIG. 3 illustrates a particular number of users 301, client systems 330, social-networking systems 360, third-party systems 370, and networks 310, this disclosure contemplates any suitable number of users 301, client systems 330, social-networking systems 360, third-party systems 370, and networks 310. As an example and not by way of limitation, network environment 300 may include multiple users 301, client system 330, social-networking systems 360, third-party systems 370, and networks 310.

In particular embodiments, user 301 may be an individual (human user), an entity (e.g., an enterprise, business, or third-party application), or a group (e.g., of individuals or entities) that interacts or communicates with or over social-networking system 360. In particular embodiments, social-networking system 360 may be a network-addressable computing system hosting an online social network. Social-networking system 360 may generate, store, receive, and send social-networking data, such as, for example, user-profile data, concept-profile data, social-graph information, or other suitable data related to the online social network. Social-networking system 360 may be accessed by the other components of network environment 300 either directly or via network 310. In particular embodiments, social-networking system 360 may include an authorization server that allows users 301 to opt in or opt out of having their actions logged by social-networking system 360 or shared with other systems (e.g., third-party systems 370), such as, for example, by setting appropriate privacy settings. In particular embodiments, third-party system 370 may be a network-addressable computing system that can host images. Third-party system 370 may generate, store, receive, and send images, such as, for example, HDR images. Third-party system 370 may be accessed by the other components of network environment 300 either directly or via network 310. In particular embodiments, one or more users 301 may use one or more client systems 330 to access, send data to, and receive data, such as, for example, images, from social-networking system 360 or third-party system 370. Client system 330 may access social-networking system 360 or third-party system 370 directly, via network 310, or via a third-party system. As an example and not by way of limitation, client system 330 may access third-party system 370 via social-networking system 360. Client system 330 may be any suitable computing device, such as, for example, a personal computer, a laptop computer, a cellular telephone, a smartphone, or a tablet computer.

This disclosure contemplates any suitable network 310. As an example and not by way of limitation, one or more portions of network 310 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 310 may include one or more networks 310.

Links 350 may connect client system 330, social-networking system 360, and third-party system 370 to communication network 310 or to each other. This disclosure contemplates any suitable links 350. In particular embodiments, one or more links 350 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 350 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 350, or a combination of two or more such links 350. Links 350 need not necessarily be the same throughout network environment 300. One or more first links 350 may differ in one or more respects from one or more second links 350.

FIG. 4 illustrates example social graph 400. In particular embodiments, social-networking system 360 may store one or more social graphs 400 in one or more data stores. In particular embodiments, social graph 400 may include multiple nodes—which may include multiple user nodes 402 or multiple concept nodes 404—and multiple edges 406 connecting the nodes. Example social graph 400 illustrated in FIG. 4 is shown, for didactic purposes, in a two-dimensional visual map representation. In particular embodiments, a social-networking system 360, client system 330, or third-party system 370 may access social graph 400 and related social-graph information for suitable applications. The nodes and edges of social graph 400 may be stored as data objects, for example, in a data store (such as a social-graph database). Such a data store may include one or more searchable or queryable indexes of nodes or edges of social graph 400.

In particular embodiments, a user node 402 may correspond to a user of social-networking system 360. As an example and not by way of limitation, a user may be an individual (human user), an entity (e.g., an enterprise, business, or third-party application), or a group (e.g., of individuals or entities) that interacts or communicates with or over social-networking system 360. In particular embodiments, when a user registers for an account with social-networking system 360, social-networking system 360 may create a user node 402 corresponding to the user, and store the user node 402 in one or more data stores. Users and user nodes 402 described herein may, where appropriate, refer to registered users and user nodes 402 associated with registered users. In addition or as an alternative, users and user nodes 402 described herein may, where appropriate, refer to users that have not registered with social-networking networking system 360. In particular embodiments, a user node 402 may be associated with information provided by a user or information gathered by various systems, including social-networking system 360. As an example and not by way of limitation, a user may provide his or her name, profile picture, contact information, birth date, sex, marital status, family status, employment, education background, preferences, interests, or other demographic information. In particular embodiments, a user node 402 may be associated with one or more data objects corresponding to information associated with a user. In particular embodiments, a user node 402 may correspond to one or more webpages.

In particular embodiments, a concept node 404 may correspond to a concept. As an example and not by way of limitation, a concept may correspond to a place (such as, for example, a movie theater, restaurant, landmark, or city); a website (such as, for example, a website associated with social-network system 360 or a third-party website associated with a web-application server); an entity (such as, for example, a person, business, group, sports team, or celebrity); a resource (such as, for example, an audio file, video file, digital photo, text file, structured document, or application) which may be located within social-networking system 360 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 404 may be associated with information of a concept provided by a user or information gathered by various systems, including social-networking system 360. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 404 may be associated with one or more data objects corresponding to information associated with concept node 404. In particular embodiments, a concept node 404 may correspond to one or more webpages.

In particular embodiments, a node in social graph 400 may represent or be represented by a webpage (which may be referred to as a “profile page”). Profile pages may be hosted by or accessible to social-networking system 360. Profile pages may also be hosted on third-party websites associated with a third-party server 370. As an example and not by way of limitation, a profile page corresponding to a particular external webpage may be the particular external webpage and the profile page may correspond to a particular concept node 404. Profile pages may be viewable by all or a selected subset of other users. As an example and not by way of limitation, a user node 402 may have a corresponding user-profile page in which the corresponding user may add content, make declarations, or otherwise express himself or herself. As another example and not by way of limitation, a concept node 404 may have a corresponding concept-profile page in which one or more users may add content, make declarations, or express themselves, particularly in relation to the concept corresponding to concept node 404.

In particular embodiments, a concept node 404 may represent a third-party webpage or resource hosted by a third-party system 370. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 330 to send to social-networking system 360 a message indicating the user's action. In response to the message, social-networking system 360 may create an edge (e.g., an “eat” edge) between a user node 402 corresponding to the user and a concept node 404 corresponding to the third-party webpage or resource and store edge 406 in one or more data stores.

In particular embodiments, a pair of nodes in social graph 400 may be connected to each other by one or more edges 406. An edge 406 connecting a pair of nodes may represent a relationship between the pair of nodes. In particular embodiments, an edge 406 may include or represent one or more data objects or attributes corresponding to the relationship between a pair of nodes. As an example and not by way of limitation, a first user may indicate that a second user is a “friend” of the first user. In response to this indication, social-networking system 360 may send a “friend request” to the second user. If the second user confirms the “friend request,” social-networking system 360 may create an edge 406 connecting the first user's user node 402 to the second user's user node 402 in social graph 400 and store edge 406 as social-graph information in one or more of data stores 24. In the example of FIG. 4, social graph 400 includes an edge 406 indicating a friend relation between user nodes 402 of user “A” and user “B” and an edge indicating a friend relation between user nodes 402 of user “C” and user “B.” Although this disclosure describes or illustrates particular edges 406 with particular attributes connecting particular user nodes 402, this disclosure contemplates any suitable edges 406 with any suitable attributes connecting user nodes 402. As an example and not by way of limitation, an edge 406 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 400 by one or more edges 406.

In particular embodiments, an edge 406 between a user node 402 and a concept node 404 may represent a particular action or activity performed by a user associated with user node 402 toward a concept associated with a concept node 404. As an example and not by way of limitation, as illustrated in FIG. 4, a user may “like,” “attended,” “played,” “listened,” “cooked,” “worked at,” or “watched” a concept, each of which may correspond to a edge type or subtype. A concept-profile page corresponding to a concept node 404 may include, for example, a selectable “check in” icon (such as, for example, a clickable “check in” icon) or a selectable “add to favorites” icon. Similarly, after a user clicks these icons, social-networking system 360 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social-networking system 360 may create a “listened” edge 406 and a “used” edge (as illustrated in FIG. 4) between user nodes 402 corresponding to the user and concept nodes 404 corresponding to the song and application to indicate that the user listened to the song and used the application. Moreover, social-networking system 360 may create a “played” edge 406 (as illustrated in FIG. 4) between concept nodes 404 corresponding to the song and the application to indicate that the particular song was played by the particular application. In this case, “played” edge 406 corresponds to an action performed by an external application (SPOTIFY) on an external audio file (the song “Imagine”). Although this disclosure describes particular edges 406 with particular attributes connecting user nodes 402 and concept nodes 404, this disclosure contemplates any suitable edges 406 with any suitable attributes connecting user nodes 402 and concept nodes 404. Moreover, although this disclosure describes edges between a user node 402 and a concept node 404 representing a single relationship, this disclosure contemplates edges between a user node 402 and a concept node 404 representing one or more relationships. As an example and not by way of limitation, an edge 406 may represent both that a user likes and has used at a particular concept. Alternatively, another edge 406 may represent each type of relationship (or multiples of a single relationship) between a user node 402 and a concept node 404 (as illustrated in FIG. 4 between user node 402 for user “E” and concept node 404 for “SPOTIFY”).

In particular embodiments, social-networking system 360 may create an edge 406 between a user node 402 and a concept node 404 in social graph 400. As an example and not by way of limitation, a user viewing a concept-profile page (such as, for example, by using a web browser or a special-purpose application hosted by the user's client system 330) may indicate that he or she likes the concept represented by the concept node 404 by clicking or selecting a “Like” icon, which may cause the user's client system 330 to send to social-networking system 360 a message indicating the user's liking of the concept associated with the concept-profile page. In response to the message, social-networking system 360 may create an edge 406 between user node 402 associated with the user and concept node 404, as illustrated by “like” edge 406 between the user and concept node 404. In particular embodiments, social-networking system 360 may store an edge 406 in one or more data stores. In particular embodiments, an edge 406 may be automatically formed by social-networking system 360 in response to a particular user action. As an example and not by way of limitation, if a first user uploads a picture, watches a movie, or listens to a song, an edge 406 may be formed between user node 402 corresponding to the first user and concept nodes 404 corresponding to those concepts. Although this disclosure describes forming particular edges 406 in particular manners, this disclosure contemplates forming any suitable edges 406 in any suitable manner.

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system may encompass a computing device, and vice versa, where appropriate. Moreover, reference to a computer system may encompass one or more computer systems, where appropriate.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, receiving information associated with an image;
by the computing device, receiving information regarding a viewing context for displaying the image;
by the computing device, customizing the image with respect to the viewing context; and
by the computing device, providing the customized image for display.

2. The method of claim 1, wherein customizing the image comprises customizing metadata associated with the image, and wherein providing the customized image comprises providing the image with the customized metadata.

3. The method of claim 2, wherein the image has a high dynamic range, and wherein the image was created based on a set of images of a subject, each image in the set of images having a different exposure level.

4. The method of claim 1, wherein customizing the image comprises generating a new version of the image, and wherein providing the customized image comprises providing the new version of the image.

5. The method of claim 1, further comprising:
receiving a request to display the image on a display device, wherein the viewing context comprises technical specifications for the display device.

6. The method of claim 5, wherein the technical specifications for the display device comprise: dynamic range maximum colors, screen resolution, screen dimensions, pixel density, pixels per degree, aspect ratio, maximum viewing angle, typical viewing distance, brightness, response time, photosensor capabilities, networking capabilities, GPS capabilities, or battery life.

7. The method of claim 1, wherein the viewing context comprises information regarding a physical environment of the display device, the physical environment comprising: ambient light, location, time of day, or time of year.

8. The method of claim 1, wherein the viewing context comprises information regarding a state of the display device, the state comprising: power availability, user-configurable display settings, or network connectivity.

9. The method of claim 1, wherein the viewing context comprises information regarding user viewing preferences.

10. The method of claim 9, wherein the user viewing preferences comprise preferences of a user associated with the display device.

11. The method of claim 9, wherein the user viewing preferences comprise preferences of an expert user.

12. The method of claim 9, wherein the user viewing preferences comprise preferences of one or more social-networking connections of a user associated with the display device.

13. One or more computer-readable non-transitory storage media embodying software that is operable when executed to:
by a computing device, receive information associated with an image;
by the computing device, receive information regarding a viewing context for displaying the image;
by the computing device, customize the image with respect to the viewing context; and
by the computing device, provide the customized image for display.

14. The media of claim 13, wherein the software operable to customize the image comprises software operable to customize metadata associated with the image, and wherein the software operable to provide the customized image comprises software operable to provide the image with the customized metadata.

15. The media of claim 14, wherein the image has a high dynamic range, and wherein the image was created based on a set of images of a subject, each image in the set of images having a different exposure level.

16. The media of claim 13, wherein the viewing context comprises information regarding user viewing preferences.

17. A system comprising:
one or more processors; and
a memory coupled to the processors comprising instructions executable by the processors, the processors being operable when executing the instructions to:
receive information associated with an image;
receive information regarding a viewing context for displaying the image;
customize the image with respect to the viewing context; and
provide the customized image for display.

18. The system of claim 17, wherein the processors being operable to customize the image comprises the processors being operable to customize metadata associated with the image, and wherein the processors being operable to provide the customized image comprises the processors being operable to provide the image with the customized metadata.

19. The system of claim 18, wherein the image has a high dynamic range, and wherein the image was created based on a set of images of a subject, each image in the set of images having a different exposure level.

20. The system of claim 17, the processors being further operable when executing the instructions to:
receive a request to display the image on a display device, wherein the viewing context comprises technical specifications for the display device.
